(19) United States
(12) Patent Application Publication
(10) Pub. No.: US 2005/0258000 A1
(43) Pub. Date: Nov. 24, 2005

(54) Noise reducing equipment

(76) Inventors: Hiroshi Yano, Akashi City (JP); Mitsuaki Oda, Akashi City (JP)

Correspondence Address: ANDERSON, KILL & OLICK, P.C., 1251 AVENUE OF THE AMERICAS, NEW YORK,, NY, 10020-1182, US

(21) Appl. No.: 10/851,788

(22) Filed: May 20, 2004

(51) Int. Cl. B64F 1/26; G10K 11/00; E04H 17/00; F01N 7/18

(52) U.S. Cl. 181/210

(57) ABSTRACT

The noise reducing equipment of the present invention is used in combination with a vertically oriented sound barrier wall to reduce the level of noise from a source of sound such as traffic generated on one side of the sound barrier wall and comprises an assembly composed of a predetermined number of interconnected resonant chambers mounted in tandem to a sound barrier wall such that the assembly of resonant chambers extends from the sound barrier wall on only the side thereof opposite the source of generated sound and at a location adjacent the top end thereof with each of the resonant chambers having a plurality of walls defining separate volumetric areas with the resonant chamber closest to the sound barrier wall having a volumetric area larger than the volumetric area of each of the other resonant chambers. The noise reducing equipment should also include a plurality of sections composed of sound absorption material in an arrangement with each section extending between adjacent resonant chambers and being laterally spaced apart from one another to form an opening to each resonant chamber.

### FIELD OF INVENTION

This invention relates to the field of sound abatement and more particularly to noise reducing equipment for use in combination with a sound barrier such as a wall for reducing the level of noise particularly from traffic sounds.

### BACKGROUND OF THE INVENTION

It is known to use a sound barrier wall for reducing and impeding the transmission of sound waves. A sound barrier wall can, for example, be installed alongside an expressway to confine and minimize traffic noise generated by passing automobiles. It is also known to add resonance equipment on top of a sound barrier wall which includes several different type of Helmholtz resonators responsive to selected resonance frequencies of the source of noise to be abated so as to more effectively minimize the noise level at the barrier wall and confine the level of noise to an acceptable level. An arrangement consisting of a combination of a sound barrier wall and resonance equipment is disclosed in Japanese Patent No. P3485552 for reducing noise from e.g. traffic to an acceptable low level. The sound resonance equipment disclosed in this patent publication includes an outer shell which surrounds a plurality of resonant chambers responsive to different resonance frequencies and includes means for mounting the resonance equipment to the top of a vertically installed sound barrier wall to form a substantially uniform arrangement of an equal number of resonant chambers on each opposite side of the sound barrier wall.

Although the sound resonance equipment taught and described in the aforementioned Japanese Patent No. P3485552 is effective for reducing noise the construction and installation requirements to form a substantially uniform arrangement of an equal number of resonant chambers on each opposite side of the sound barrier wall is expensive, difficult to maintain and unsightly in appearance. Less expensive noise reducing equipment which can be more easily installed and maintained without any noticeable decrease in its effectiveness to abate noise is the principal object of the present invention.

### SUMMARY OF THE INVENTION

Noise reducing equipment has been discovered in accordance with the present invention for attachment to a sound barrier wall that is at least as effective in reducing noise as compared to the equipment disclosed in the aforementioned Japanese patent publication. The noise reducing equipment of the present invention comprises an assembly composed of a predetermined number of interconnected resonant chambers mounted in tandem and connected to said sound barrier wall such that the assembly of resonant chambers extend from said sound barrier wall from only the side thereof opposite the source of generated sound and at a location adjacent the top end of the wall with each of the resonant chambers having a plurality of walls defining separate volumetric areas with the resonant chamber closest to the sound barrier wall having a volumetric area larger than the volumetric area of each of the other resonant chambers.

More particularly, the noise reducing equipment of the present invention to be used in combination with a sound barrier wall comprises: an assembly composed of at least three resonant chambers, mounted in tandem and connected to said sound barrier wall such that the assembly of resonant chambers extend from said sound barrier wall from only the side thereof opposite the source of generated sound and at a location adjacent the top end thereof with each of the resonant chambers having a plurality of walls which define a separate volumetric area for each resonant chamber, with the resonant chamber having the largest volumetric area being closets to the sound barrier wall and further comprising a plurality of sections composed of sound absorption material with each section extending in a lateral arrangement between adjacent resonant chambers and being spaced apart from one another to form an opening to each resonant chamber.

It is further preferred that the opening in each resonant chamber be either symmetrically aligned with the top end of the barrier wall or be at an inclined position relative to one another with the opening in the first resonant chamber located adjacent the top end of the sound barrier wall and with the other openings positioned above the top end of the barrier wall.

### BRIEF DESCRIPTION OF THE DRAWINGS

Further advantages and objects of the present invention will become apparent from the following detailed description of the preferred embodiment when read in conjunction with the following drawings of which:

FIG. 1 illustrates a prior art configuration of noise reducing equipment shown mounted upon a vertically oriented sound barrier wall.

FIG. 2 is an enlarged isometric view of the prior art assembly of resonant chambers in the noise reducing equipment of FIG. 1;

FIG. 3 is a schematic view in cross section of one configuration of the noise reducing equipment of the present invention with the assembly of resonant chambers shown side mounted against only one side of a vertically oriented sound barrier wall;

FIGS. 4 is a schematic illustration of a variation in the configuration of the assembly of resonant chambers of FIG. 3;

FIG. 5 is an isometric view of a preferred embodiment of the noise reducing equipment of the present invention with the assembly of resonant chambers of FIG. 4 shown mounted in one configuration against one side of a vertically oriented sound barrier wall;

FIG. 6 is an acoustical analysis model of the noise reducing equipment of FIG. 3;

FIG. 7 is a schematic view in cross section of another side mounted configuration for the assembly of resonant chambers of. FIG. 4 against one side of a vertically oriented sound barrier wall; and

FIG. 8 is a schematic view in cross section of the assembly of resonant chambers of FIGS. 3 and 4 mounted in another configuration to the top end of a vertically oriented sound barrier wall.

### DETAILED DESCRIPTION OF THE INVENTION

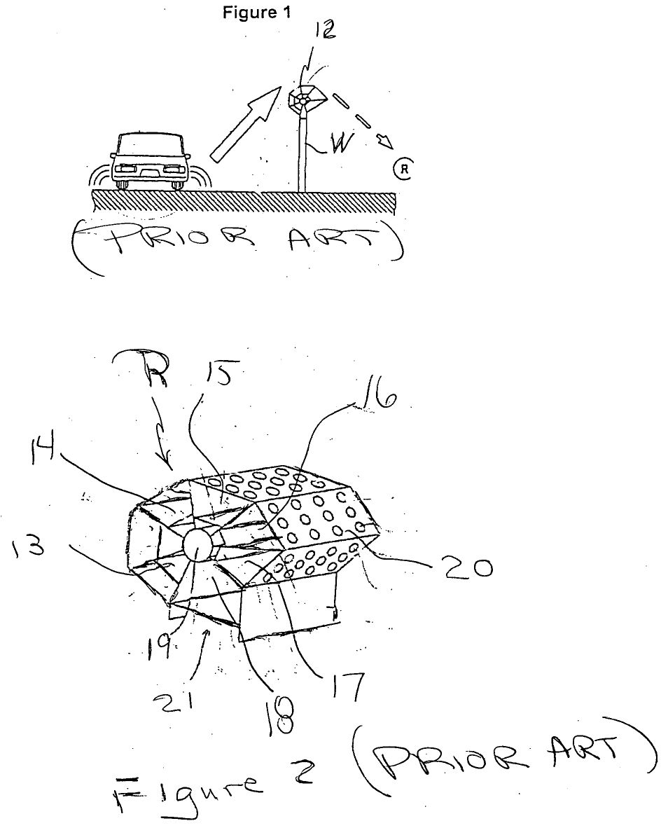

A prior art configuration of noise reducing equipment for traffic noise is shown in FIG. 1 and corresponds to that described in Japanese Patent No. P3485552. FIG. 2 is an enlarged isometric view of the prior art assembly of resonant chambers in the noise reducing equipment of FIG. 1.

The sound barrier wall W is constructed of, for example, concrete and is vertically erected to form a partition between a source of sound such as traffic noise generated from passing automobiles on one side of the vertically oriented sound barrier wall W and an observation point R located on the opposite side of the wall W. A resonator 12, representing an assembly of resonant chambers is mounted on the vertical top end of the sound barrier wall with the resonant chambers arranged to be substantially symmetrically disposed on each opposite side of the sound barrier wall so as to uniformly inhibit the propagation of sound waves at the wall. The propagation of sound waves from a sound source is impeded by the sound barrier wall W and diffracted from the top of the wall W where it enters the resonator 12. Since the noise reducing equipment provides a pre-defined resonance frequency, incident wave and reflecting wave can counterbalance each other at the surface of the resonator 12 when frequency of incident wave matches the resonance frequency causing the phase of reflecting wave from the resonator to be inverted (i.e., the phase is shifted by 180°). The resonance frequency can be pre-defined to correspond to the frequencies of targeted sound waves.

The resonator R is of a configuration as is shown in FIG. 2 defining an arrangement of an even number of resonating chambers, each of which constitutes a separate resonator, with each resonating chamber radially extending from a central core 19. In FIG. 2, six resonating chambers 13, 14, 15, 16, 17 and 18 are shown having a common outer shell 20 covering all of the chambers. The outer shell 20 can be an elastic film with openings or a perforated solid in which the perforations functions as multiple openings to each of the resonating chambers. Each of the resonating chambers is formed of a plurality of separator walls with each defining a different volumetric area and a different resonance frequency or have a common volume and a common resonance frequency. A mounting platform 21 extends vertically from the resonator R to enable the resonator R to be mounted above the top of the sound barrier wall W so that an equal number of resonating chambers will extend from each opposite side of the wall W. In an alternate arrangement disclosed in Japanese Patent Publication No. 2002-220817 the resonating chambers are mounted on opposite sides of the sound barrier wall and aligned in parallel so that the openings to the chambers are level with respect to each other. The resonance frequency of each of the resonators can vary by changing either the volume of the resonant chambers and/or by changing the inner diameters of the inlet openings or holes to the resonant chambers. Alternatively, the resonance frequency can also be varied by using an elastic film membrane for some of the wall dividers and changing the elastic density of the elastic film membrane.

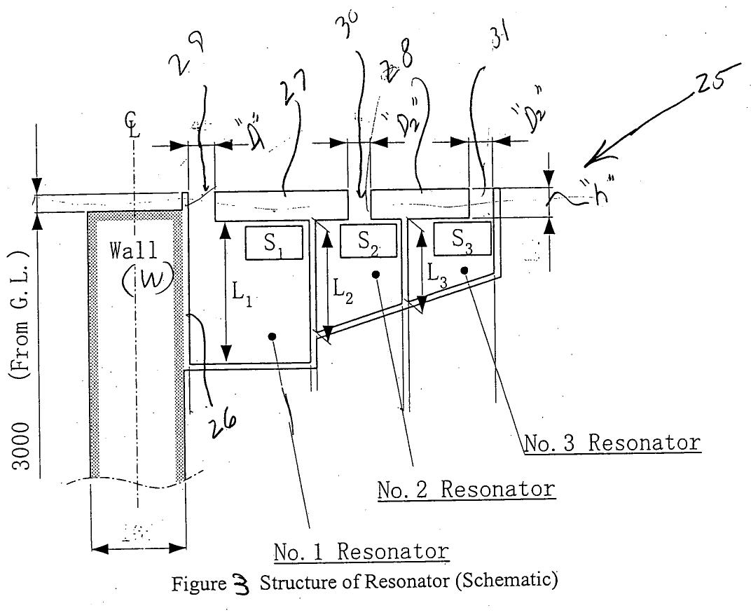

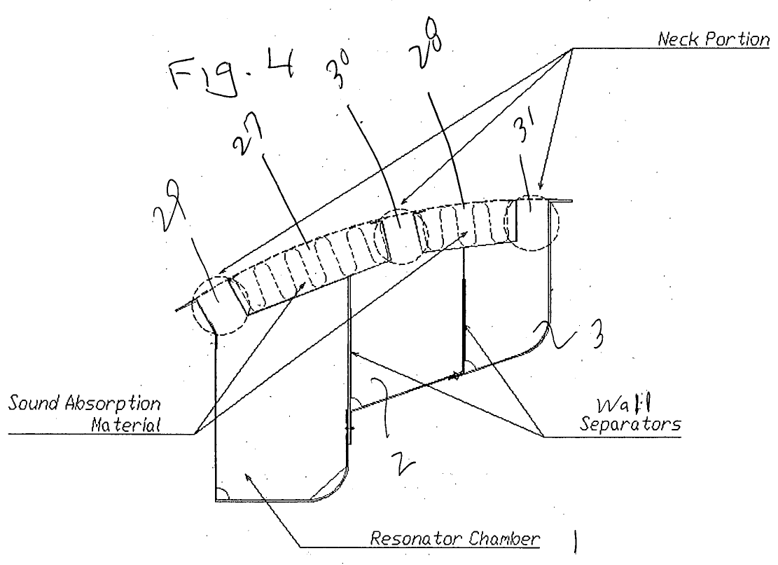

It has been discovered in accordance with the present invention that as long as the assembly of resonant chambers is mounted in tandem to said sound barrier wall and extend from only the side of the barrier wall opposite the source of generated sound with the resonant chamber closest to the sound barrier wall having a volumetric area larger than the volumetric area of each of the other resonant chambers the assembly in combination with a vertically erected sound barrier wall can be as effective in noise reduction as that of a substantially symmetrically mounted noise reduction unit having an equal number of resonant chambers disposed on the opposite sides of the sound barrier wall. Moreover, higher soundproof efficiency can be realized by incorporating sections of sound absorption material between the radiant chambers as illustrated in FIG. 3.

The noise reducing equipment of the present invention is illustrated in FIGS. 3-8 inclusive. The structural assembly 25 of resonant chambers as shown in FIG. 3 consists of three resonant chambers which, in combination, form three resonators identified as Resonator No.1, Resonator No.2 and Resonator No. 3 respectively. The three resonant chambers are interconnected in tandum and are affixed to the sound barrier wall W so that the assembly extends from only one sound barrier wall surface on the side thereof opposite the source of generated sound. In the arrangement of FIG. 3 the three resonator chambers 1,2 and 3 are side mounted against the sound barrier wall on the side thereof opposite the source of generated sound and are not easily visible from the opposite side. Each resonator includes a plurality of walls and wall separators which define separate volumetric areas S₁, S₂ and S₃ respectively for each of the three resonators 1,2 and 3. The resonator with the largest volumetric area is Resonator No. 1 which includes a wall 26 mounted in parallel alignment against one side of the sound barrier wall W. The wall 26 of Resonator No.1 provides enhanced structural support for the assembly 25. A plurality of sections 27 and 28 composed of conventional sound absorption material, such as glass wool, extend between adjacent resonant chambers in lateral alignment relative to one another and are spaced apart, such that a plurality of openings 29, 30 and 31 are formed for defining separate inlet openings to each of the resonators No. 1, No.2, and No. 3 respectively. The width (diameter) and depth (height ) of the inlet openings 29, 30 and 31 are variables for controlling the resonance frequency of each of the resonators.

The configuration of FIG. 3 is designed for target frequencies from low to mid range in a bandwidth under 500 Hz. The height “h” of each inlet opening 29, 30 and 31 corresponds to the thickness of the sections 27 and 28 of sound absorption material whereas the diameter “D” or width is also a fixed variable for establishing an aperture ratio between the height and diameter. The resonance frequencies are tuned by changing the length “L” of each Resonator Chamber.

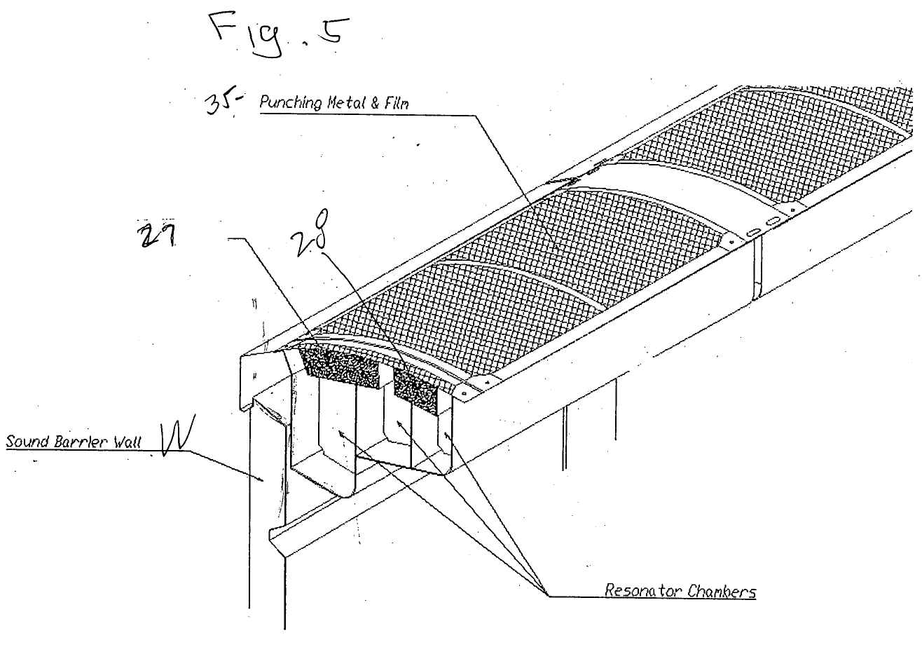

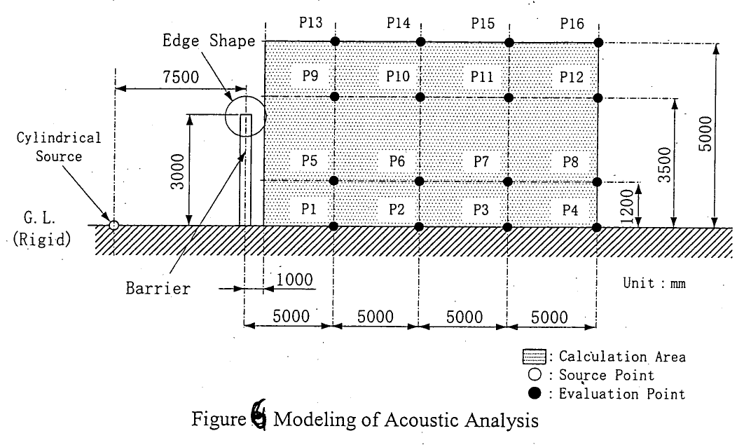

FIGS. 4 is a schematic illustration of a variation in the configuration of the assembly of resonant chambers shown in FIG. 3 in which each inlet opening 29, 30 and 31 lies at an increasing height relative to one another with the inlet opening 29 located at substantially the same height as the top end of the sound barrier wall and with each of the other inlet openings 30 and 31 being at a vertically higher level. FIG. 5 is a configuration of an assembly 25 of resonant chambers similar to FIG. 4 which is shown side mounted against one side of a sound barrier wall W and includes an outer shell 35 for covering each the three resonators No.1,No.2, and No.3 in common. The outer shell 35 has an extension 36 mounted upon the top end of the sound barrier wall. The inlet openings 29, 30 and 31 as shown in FIG. 4 constitute the inlet opening neck portions to each of the three resonant chambers 1, 2 and 3 respectively. The sections 27 and 28 of sound absorption material are of a uniform thickness and extend between the adjacent resonant chambers 1,2 and 3 equivalent to the configuration of FIG. 3. However, in this configuration each inlet opening 29, 30 and 31 is at a different vertical level relative to one another equivalent to the arrangement shown in FIG. 4.and the outer shell 35 is shown as a perforated covering but can likewise be solid with or without an elastic film membrane composed preferably from a polyvinyl composition. In the preferred construction as is shown in FIG. 5 the outer shell 35 is a perforated metal composition, the walls of the resonant chambers are formed of aluminum and the sound absorption material 27 and 28 is composed of glasswool.

The following Table 1 shows the configuration of FIG. 3 with the parameters varied to establish different resonance frequencies for four different cases based only on a resonance assembly type without a cover hereafter referred to as “soft”. The type of assembly using a cover is either classified as “hard” or “hybrid”. In each instance the volumetric area S₁ of the first resonator No. 1 is larger than the volumetric area of the other resonators. In the configuration of FIG. 3 the Resonator 1 laterally extends 200 mm from the wall W and each Resonator 2 and 3 laterally extends an additional distance of 145 mm respectively.

TABLE 1

| Type | No. 1 Resonator | | | No. 2 Resonator | | | No.3 Resonator | | |
|---|---|---|---|---|---|---|---|---|---|
| Soft_1 | D₁ | 45 | mm | D₂ | 40 | mm | D₃ | 40 | mm |
| | L₁ | 240 | mm | L₂ | 190 | mm | L₃ | 140 | mm |
| | S₁ | 48000.00 | mm² | S₂ | 24158.86 | mm² | S₃ | 16908.87 | mm² |
| | fᵣ₁ | 188.3 | Hz | fᵣ₂ | 271.9 | Hz | fᵣ₃ | 325.0 | Hz |
| | | (200 | Hz) | | (250 | Hz) | | (315 | Hz) |
| Soft_2 | D₁ | 45 | mm | D₂ | 40 | mm | D₃ | 40 | mm |
| | L₁ | 180 | mm | L₂ | 190 | mm | L₃ | 70 | mm |
| | S₁ | 36000.00 | mm² | S₂ | 24158.86 | mm² | S₃ | 8454.43 | mm² |
| | fᵣ₁ | 217.5 | Hz | fᵣ₂ | 271.9 | Hz | fᵣ₃ | 459.6 | Hz |
| | | (200 | Hz) | | (250 | Hz) | | (500 | Hz) |
| Soft_3 | D₁ | 45 | mm | D₂ | 40 | mm | D₃ | 40 | mm |
| | L₁ | 240 | mm | L₂ | 190 | mm | L₃ | 92 | mm |
| | S₁ | 48000.00 | mm² | S₂ | 24158.86 | mm² | S₃ | 11096.45 | mm² |
| | fᵣ₁ | 188.3 | Hz | fᵣ₂ | 271.9 | Hz | fᵣ₃ | 401.1 | Hz |
| | | (200 | Hz) | | (250 | Hz) | | (400 | Hz) |
| Soft_4 | D₁ | 45 | mm | D₂ | 40 | mm | D₃ | 40 | mm |
| | L₁ | 122 | mm | L₂ | 127 | mm | L₃ | 70 | mm |
| | S₁ | 24400.00 | mm² | S₂ | 16105.92 | mm² | S₃ | 8454.43 | mm² |
| | fᵣ₁ | 264.1 | Hz | fᵣ₂ | 333.0 | Hz | fᵣ₃ | 459.6 | Hz |
| | | (250 | Hz) | | (315 | Hz) | | (500 | Hz) |

*The frequencies in “( )” are One-Third Octave Band frequencies.

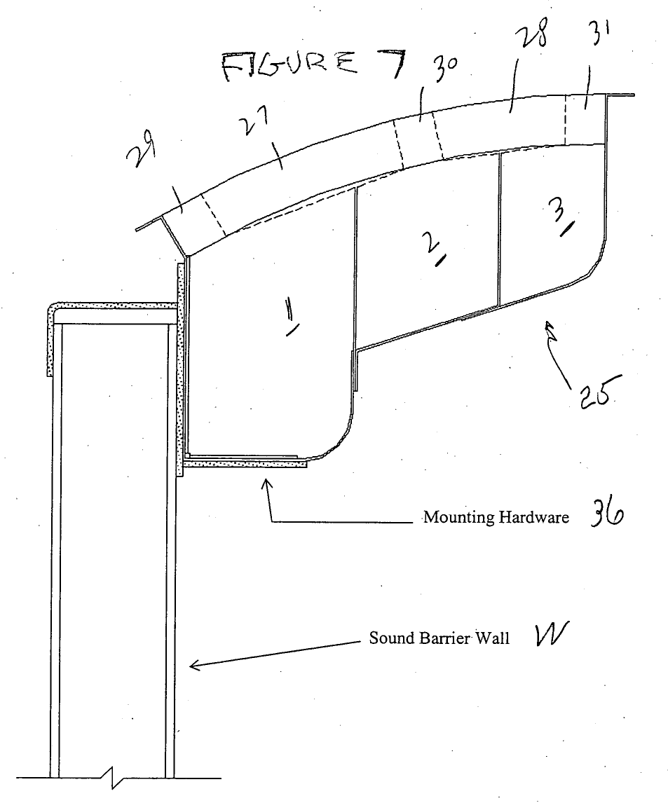

An acoustical analysis model to evaluate the performance of the configuration of FIG. 3 is shown in FIG. 6 at different evaluation points from P1 to P16 respectively. FIG. 6 indicates the evaluation point heights relative to ground level (GL). The following dimensions were used for the acoustical analysis:
Height of the Sound Barrier Wall (W): 3 m
Thickness of the Sound Barrier Wall: 160 mm
Location of the Sound Source: 7.5 m sideward from the center of the sound barrier wall, at the ground level
Computed Region: 1 to 20 m sideward from the sound barrier wall, 0 to 5 m upward from the ground level
Evaluation Points: at 5, 10, 15, 20 m sideward from the center of the sound barrier wall, at 0, 1.2, 3.5, 5 m upward from the ground level (P1 through P16)
Type of Source: Road Traffic Noise Spectrum
Type of Media: Air (Speed of Sound: 340 m/s, Density: 1.225 kg/m³)
Computed Frequency: 100 to 2500 by One-Third Octave Band

Noise level and sound pressure reduction level measurements per one-third octave band frequency characteristics were taken at each evaluation point. The overall value of the reduction level at each evaluation point is summarized in the following Table 2.

TABLE 2
Overall values of Noise Reduction Level for each Analyzing Model
(H: Hard, S_1: Soft_1, S_2: Soft_2, S_3: Soft_3, S_4: Soft_4)

| | | | | | | | | | | | |
|---|---|---|---|---|---|---|---|---|---|---|---|
| P13 | −0.7 | (H) | P14 | −0.4 | (H) | P15 | −0.1 | (H) | P16 | −0.1 | (H) |
| | −0.3 | (S_1) | | 0.3 | (S_1) | | 0.7 | (S_1) | | 0.9 | (S_1) |
| | −0.3 | (S_2) | | 0.4 | (S_2) | | 0.7 | (S_2) | | 0.9 | (S_2) |
| | −0.3 | (S_3) | | 0.4 | (S_3) | | 0.8 | (S_3) | | 0.9 | (S_3) |
| | −0.3 | (S_4) | | 0.5 | (S_4) | | 0.8 | (S_4) | | 1.0 | (S_4) |
| P9 | −0.2 | (H) | P10 | 0.2 | (H) | P11 | 0.1 | (H) | P12 | 0.2 | (H) |
| | 0.8 | (S_1) | | 1.1 | (S_1) | | 1.3 | (S_1) | | 1.5 | (S_1) |
| | 0.8 | (S_2) | | 1.1 | (S_2) | | 1.2 | (S_2) | | 1.3 | (S_2) |
| | 0.8 | (S_3) | | 1.1 | (S_3) | | 1.3 | (S_3) | | 1.5 | (S_3) |
| | 0.9 | (S_4) | | 1.2 | (S_4) | | 1.4 | (S_4) | | 1.6 | (S_4) |
| P5 | 1.6 | (H) | P6 | 0.9 | (H) | P7 | 0.7 | (H) | P8 | 0.6 | (H) |
| | 3.6 | (S_1) | | 2.5 | (S_1) | | 1.8 | (S_1) | | 1.4 | (S_1) |
| | 3.2 | (S_2) | | 2.5 | (S_2) | | 1.8 | (S_2) | | 1.3 | (S_2) |
| | 3.4 | (S_3) | | 2.6 | (S_3) | | 1.9 | (S_3) | | 1.4 | (S_3) |
| | 3.2 | (S_4) | | 2.9 | (S_4) | | 1.8 | (S_4) | | 1.3 | (S_4) |
| P1 | 2.1 | (H) | P2 | 1.1 | (H) | P3 | 0.8 | (H) | P4 | 0.6 | (H) |
| | 3.4 | (S_1) | | 2.7 | (S_1) | | 2.2 | (S_1) | | 1.9 | (S_1) |
| | 3.4 | (S_2) | | 2.5 | (S_2) | | 2.1 | (S_2) | | 1.8 | (S_2) |
| | 3.4 | (S_3) | | 2.7 | (S_3) | | 2.2 | (S_3) | | 1.9 | (S_3) |
| | 3.7 | (S_4) | | 2.5 | (S_4) | | 2.1 | (S_4) | | 1.8 | (S_4) |

The average overall values of reduction levels at evaluation points below the height of 1.2 m (i.e. point P1 though P8) are as follows.

| | |
|---|---|
| Hard: | 1.1 dB |
| Soft_1: | 2.4 dB |
| Soft_2: | 2.3 dB |
| Soft_3: | 2.4 dB |
| Soft_4: | 2.4 dB |

The overall average level of noise reduction for the same evaluation points for the prior art symmetric type is 3.0 dB whereas the soft type side mounted assembly as indicated above is lower. Therefore, for the higher frequency ranges (1000 Hz or more) the reduction levels for the one-side mounted assembly is smaller than a symmetric two sided mounted type.

However, the overall average level of noise reduction for a hybrid type i.e. with a cover of metal or punched metal in combination with the sections of soundproof material was also determined to be 3.1 dB and 3.0 dB respectively for the target frequencies (low to mid ranges) are well obtained with one-side mounted type. Accordingly, the hybrid type is preferred over the soft type.

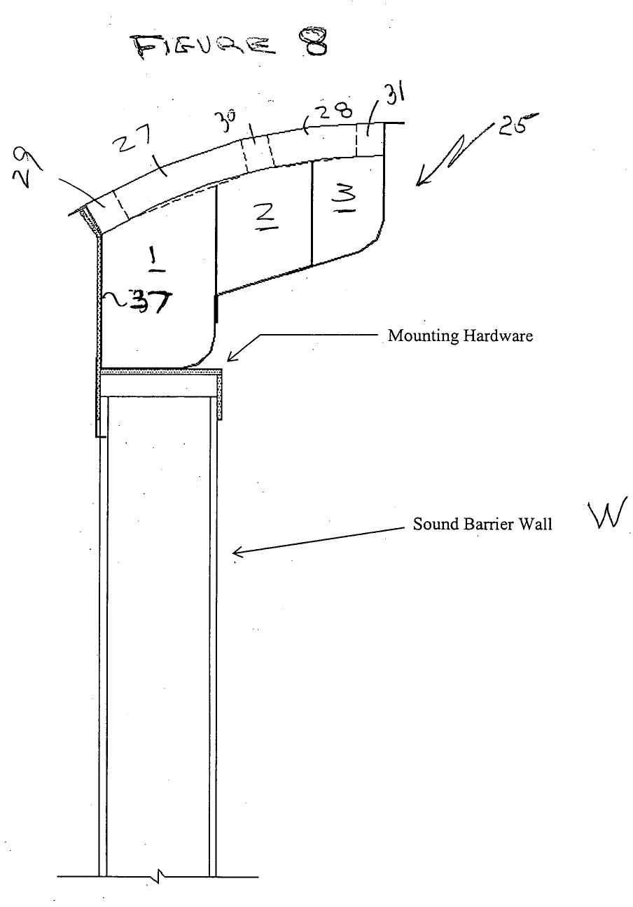

FIG. 7 is a schematic view in cross section of the assembly of resonant chambers of FIG. 4 shown side mounted against the sound barrier wall W on one side thereof using additional mounting hardware 36. An alternative mounting arrangement is shown in FIG. 8 in which the assembly 25 of resonant chambers is mounted upon the top end of the vertically oriented sound barrier wall W with the resonant chamber having the largest volumetric area directly mounted to the top end and with one wall 37 thereof vertically aligned with the side of the sound barrier wall W facing the source of generated sound and the remaining resonant chambers extending from the side of the sound barrier wall opposite the source of generated sound. This configuration is useful when lateral space from the sound barrier wall W is limited.

1. Noise reducing equipment for use in combination with a vertically oriented sound barrier wall having a top end and opposite sides for reducing the noise generated from a source of sound located on one of the sides of the sound barrier wall comprising an assembly composed of a predetermined number of interconnected resonant chambers mounted in tandem to said sound barrier wall such that the assembly of resonant chambers extends from said sound barrier wall on only the side thereof opposite the source of generated sound and at a location adjacent the top end with each of the resonant chambers having a plurality of walls defining separate volumetric areas with the resonant chamber closest to the sound barrier wall having a volumetric area larger than the volumetric area of each of the other resonant chambers.

2. Noise reducing equipment as defined in claim 1 further comprising a plurality of sections composed of sound absorbing material with each section of sound absorbing material extending in a lateral arrangement between adjacent resonant chambers and being spaced apart from one another to form an inlet opening to each of said resonant chambers respectively.

3. Noise reducing equipment as defined in claim 2 further comprising a common outer covering extending over all of said resonant chambers.

4. Noise reducing equipment as defined in claim 3 wherein said common outer covering comprises a perforated metal member.

5. Noise reducing equipment as defined in claim 4 wherein said assembly consists of three resonant chambers.

6. Noise reducing equipment as defined in claim 5 wherein each inlet opening lies at substantially the same level relative to one another.

7. Noise reducing equipment as defined in claim 5 wherein each inlet opening lies at an inclined height relative to one another with the inlet opening in the resonant chamber having the largest volumetric area being disposed at substantially the same height as the top end of the sound barrier and with each of the other inlet openings being at a vertically higher level.

8. Noise reducing equipment as defined in claim 3 wherein said assembly of resonant chambers are side mounted against the wall of the sound barrier located opposite the source of generated sound.

9. Noise reducing equipment as defined in claim 3 wherein said assembly of resonant chambers are connected to said sound barrier wall with the resonant chamber having the largest volumetric area mounted directly upon the top of the sound barrier wall with one wall thereof in substantial vertical alignment with the wall of the sound barrier located on the side thereof closets to the source of generated sound and with the remaining resonant chambers extending outwardly from the wall of the sound barrier wall opposite the source of generated sound.

10. Noise reducing equipment for use in combination with a vertically oriented sound barrier wall having a top end and opposite sides comprising: an assembly composed of at least three resonant chambers, mounted in tandem and connected to said sound barrier wall such that the assembly of resonant chambers extends from said sound barrier wall on the side thereof opposite the source of generated sound and at a location adjacent the top end thereof with each of the resonant chambers having a plurality of walls which define a separate volumetric area for each resonant chamber, with the resonant chamber having the largest volumetric area being closets to the sound barrier wall and further comprising a plurality of sections composed of sound absorption material with each section extending in a lateral arrangement between adjacent resonant chambers and being spaced apart from one another to form an opening to each resonant chamber.
